(19) United States
(12) Patent Application Publication
(10) Pub. No.: US 2026/0142191 A1
(43) Pub. Date: May 21, 2026

(54) ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Yoonhoi LEE, Yongin-si (KR); Soochan KIM, Yongin-si (KR)

(73) Assignee: SAMSUNG SDI CO., LTD., Yongin-si (KR)

(21) Appl. No.: 19/352,995

(22) Filed: Oct. 8, 2025

(30) Foreign Application Priority Data
Nov. 15, 2024 (KR) 10-2024-0163543

(51) Int. Cl. H01M 4/70; H01M 4/02; H01M 4/133; H01M 4/134; H01M 4/66; H01M 10/0525; H01M 10/0587; H01M 10/42

(52) U.S. Cl. CPC H01M 4/70; H01M 4/133; H01M 4/134; H01M 4/664; H01M 4/667; H01M 10/0525; H01M 10/0587; H01M 10/4235; H01M 2004/027

(57) ABSTRACT

Provided are an electrode for a rechargeable lithium battery, and a rechargeable lithium battery including the electrode. The electrode for a rechargeable lithium battery includes a substrate, a hydrophilic flow path disposed on the substrate and including a hydrophilic material, and an active material layer in contact with the substrate and the hydrophilic flow path.

### CROSS-REFERENCE TO RELATED APPLICATION

This application claims priority to Korean Patent Application No. 10-2024-0163543, filed in the Korean Intellectual Property Office on Nov. 15, 2024, the entire contents of which are incorporated herein by reference.

### BACKGROUND

### 1. Field

Electrodes for rechargeable lithium batteries, and rechargeable lithium batteries including the electrodes are disclosed.

### 2. Description of the Related Art

A rechargeable lithium battery may be recharged and has three or more times as high an energy density per unit weight as a conventional lead storage battery, nickel-cadmium battery, nickel hydrogen battery, nickel zinc battery and the like. A rechargeable lithium battery may be also charged at a high rate, and is thus commercially manufactured for a laptop, a cell phone, an electric tool, an electric bike, and the like, and increasing additional energy density may be advantageous.

A rechargeable lithium battery is typically manufactured by injecting an electrolyte solution into an electrode assembly, which includes a positive electrode including a positive electrode active material capable of intercalating/deintercalating lithium ions and a negative electrode including a negative electrode active material capable of intercalating/deintercalating lithium ions.

A high-capacity and high-density rechargeable lithium batteries are in demand, an electrode having a high density by increasing a weight per an area of an active material is being used.

However, the denser the electrode becomes, the less internal pores the electrode have, which may lead to issues of reducing wettability of the electrode to an electrolyte solution, and reducing an ion transport path, and as a result deteriorating capacity and cycle-life characteristics of the rechargeable lithium battery.

In addition, in a negative electrode including graphite as an electrode active material, issues due to water repellency of the graphite may be more severe.

### SUMMARY

Some example embodiments include an electrode for a rechargeable lithium battery having increased wettability of the electrode with respect to an electrolyte solution.

Some example embodiments include an electrode for a rechargeable lithium battery including a substrate, a hydrophilic flow path disposed on the substrate and including a hydrophilic material, and an active material layer in contact with the substrate and the hydrophilic flow path.

Some example embodiments include a rechargeable lithium battery including the electrode of the example embodiment.

An electrode of some example embodiments including the hydrophilic flow path can allow an aqueous electrolyte solution to substantially uniformly wet the substrate and the active material layer through a hydrophilic material, and shorten the diffusion time of the aqueous electrolyte solution into the substrate and the active material layer.

Using the electrode of some example embodiments, side reactions due to uneven wettability of the electrode can be reduced, and capacity and cycle-life characteristics of a rechargeable lithium battery may be improved.

### BRIEF DESCRIPTION OF THE DRAWINGS

FIG. 1 is a schematic view illustrating a cross-section of an electrode when the hydrophilic flow path in the electrode is in a stripe shape, according to some example embodiments.

FIG. 2 is a schematic view illustrating a case where an electrode according to some example embodiments is a negative electrode, and an electrode assembly including the negative electrode has a jelly-roll structure.

FIG. 3 to FIG. 6 are schematic views illustrating a rechargeable lithium battery according to some example embodiments.

### DETAILED DESCRIPTION

Hereinafter, example embodiments of the present disclosure are described in detail. However, these embodiments are examples, the present disclosure is not limited thereto, and the present disclosure is defined by the scope of claims.

As used herein, when a specific definition is not otherwise provided, it is understood that when an element such as a layer, film, region, or substrate is referred to as being “on” another element, the element can be directly on the other element, or intervening elements may also be present therebetween.

As used herein, when a specific definition is not otherwise provided, the singular may also include the plural. In addition, unless otherwise specified, “A or B” may mean “including A, including B, or including A and B.”

As used herein, “combination thereof” may mean a mixture, a stack, a composite, a copolymer, an alloy, a blend, or a reaction product of constituents.

As used herein, when a definition is not otherwise provided, a particle diameter may be an average particle diameter. In addition, the particle diameter may refer to an average particle diameter (D50), which indicates the diameter of particles having a cumulative volume of 50 volume % in the particle size distribution. The average particle diameter (D50) may be measured by a method known to those skilled in the art, for example, by a particle size analyzer, or by a transmission electron microscope (TEM) image, or a scanning electron microscope (SEM) image. Alternatively, a dynamic light-scattering measurement device is used to perform a data analysis, and the number of particles is counted for each particle size range. From this, the average particle diameter (D50) value may be readily obtained through a calculation. Alternatively, the average particle diameter (D50) can be measured using a laser diffraction method. When measuring by the laser diffraction method, for example, the particles to be measured are dispersed in a dispersion medium, and then introduced into a commercially available laser diffraction particle diameter measuring device (e.g., Microtrac MT 3000), and ultrasonic waves of about 28 kHz with an output of 60 W are irradiated to calculate an average particle diameter (D50) on the basis of 50% of the particle diameter distribution in the measuring device.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Electrode:

Some example embodiments include an electrode for a rechargeable lithium battery, the electrode including a substrate, a hydrophilic flow path disposed on the substrate and including a hydrophilic material, and an active material layer in contact with the substrate and the hydrophilic flow path.

The ‘hydrophilic flow path’ has high wettability for an aqueous electrolyte solution including a hydrophilic material, and provides a path for the aqueous electrolyte solution to diffuse through the hydrophilic material.

This is distinguished from a ‘through-line’ which simply perforates the substrate and/or active material layer to provide a path for the aqueous or non-aqueous electrolyte solution to pass through. An electrode including the through-line has low wettability and the aqueous electrolyte solution has difficulty diffusing into the substrate and the active material layer because the aqueous or non-aqueous electrolyte solution passes through the substrate and/or the active material layer.

In contrast, an electrode of some example embodiments including the hydrophilic flow path can allow an aqueous electrolyte solution to substantially uniformly wet the substrate and the active material layer via a hydrophilic material, and shorten the diffusion time of the aqueous electrolyte solution into the substrate and the active material layer.

Accordingly, by using the electrode of some example embodiments, side reactions due to uneven wettability of the electrode can be reduced, and the capacity and cycle-life characteristics of a rechargeable lithium battery can be improved.

Hereinafter, the electrode of some example embodiments is described in more detail.

### Hydrophilic Material

The hydrophilic material constituting the hydrophilic flow path may include at least one of SiO₂, Al₂O₃, ZnO, MgO, ZrO₂, TiO₂, SnO₂, CeO₂, CaO, SrO, BaO, Na₂O, B₂O₃, Mn₂O₃, Y₂O₃, WO₃, or a combination thereof.

For example, SiO₂ can be used as the hydrophilic material, which can exhibit higher hydrophilicity due to its high polarity.

The hydrophilic material may have a D50 particle size in a range of about 0.1 μm to about 10 μm.

By using hydrophilic materials in this range, the effect can be desired or improved even when the hydrophilic path is formed with a thin thickness.

### Location of Active Material Layer

After forming the plurality of hydrophilic flow paths on the substrate, the active material layer in contact with the substrate and the hydrophilic flow paths may be formed.

Accordingly, the active material layer may be disposed between the plurality of hydrophilic flow paths and on the plurality of hydrophilic flow paths.

### Shape of Hydrophilic Channel

The hydrophilic flow path may be plural.

Herein, the active material layer is disposed between adjacent hydrophilic flow paths and the hydrophilic flow paths, and may surround the hydrophilic flow paths.

As is described below, an electrode assembly including the electrode of some example embodiments may have a wound jelly-roll structure, and the hydrophilic flow path may include a shape that is substantially perpendicularly arranged to a wound direction of the electrode assembly. In other words, the hydrophilic flow path connects upper and lower portions of the electrode assembly and provides a path through which the aqueous electrolyte solution is diffused via the hydrophilic material.

Herein, the hydrophilic flow path may be in a form of a stripe in which a plurality of straight lines are arranged in parallel in a longitudinal direction on the substrate; or may be in a form of a mesh in which a plurality of straight lines arranged in a longitudinal direction and a plurality of straight lines arranged in a width direction intersect on the substrate.

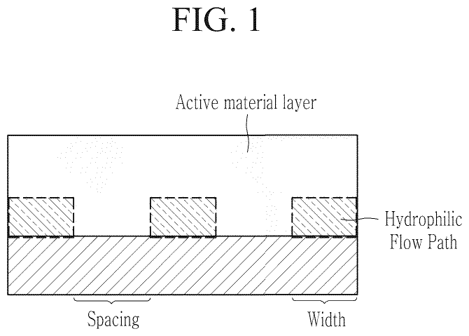

FIG. 1 is a schematic view illustrating a cross-section of an electrode when the hydrophilic flow path in the electrode is in a stripe shape, according to some example embodiments.

In the hydrophilic flow path having a stripe shape, each hydrophilic flow paths may have a width in a range of about 0.1 mm to about 10 mm, about 1 mm to about 7 mm, or about 3 mm to about 5 mm; a space between adjacent hydrophilic flow paths may be in a range of about 1 mm to about 50 mm, about 3 mm to about 30 mm; and a ratio of the width and the space may be in a range of about 1:0.5 to about 1:10, about 1:1 to about 1:5, or about 1:1 to about 3:10.

Within the above ranges, the paths for moving the electrolyte solution may be more efficiently formed, which may increase wettability for the electrolyte solution.

Regardless of the shape of the hydrophilic flow path, an area of the hydrophilic flow path may be in a range of about 1 sq % to about 60 sq % based on 100 sq % of a total area of the substrate.

Within the above ranges, the paths for moving the electrolyte solution may be more efficiently formed, which may increase wettability for the electrolyte solution.

### Rechargeable Lithium Battery:

Some example embodiments include a rechargeable lithium battery, including an electrode assembly including a positive electrode, a separator, and a negative electrode; and an electrolyte. At least one of the positive electrode and the negative electrode includes the electrode of the above example embodiments.

Such a rechargeable lithium battery may have improved capacity and cycle-life characteristics by using the electrode of the aforementioned example embodiments.

The electrode assembly may have or include a wound jelly-roll structure. Herein, the hydrophilic flow path may have a shape that is substantially orthogonal to the winding direction of the electrode assembly so as to connect the upper and lower parts of the electrode assembly. The explanations therefor are the same as described above.

Both the positive electrode and the negative electrode can be manufactured in the form of the above-described embodiment.

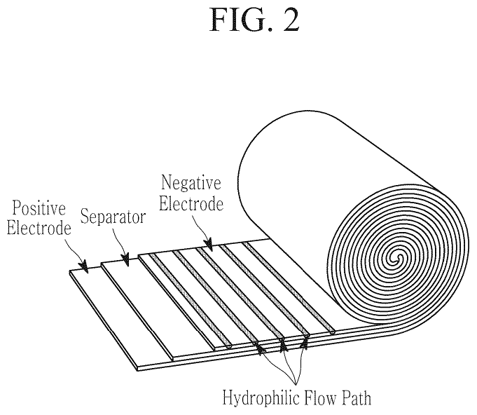

FIG. 2 is a schematic view illustrating a case where an electrode according to some example embodiments is or includes a negative electrode, and an electrode assembly including the negative electrode has a jelly-roll structure. For example, when a negative electrode including graphite as an electrode active material is manufactured in the form of the above-described example embodiment, despite the water repellency of the graphite, the wettability of the negative electrode is improved, so that a decrease in the capacity and cycle-life characteristics of a rechargeable lithium battery may be reduced or suppressed.

Hereinafter, a rechargeable lithium battery of some example embodiments is described in detail, excluding duplicate descriptions.

### Positive Electrode Active Material

The positive electrode active material may be or include a compound (lithiated intercalation compound) capable of intercalating and deintercalating lithium. For example, one or more types of composite oxides of lithium and a metal such as or including at least one of cobalt, manganese, nickel, and combinations thereof may be used.

The composite oxide may be or include a lithium transition metal composite oxide, and examples thereof may include at least one of a lithium nickel-based oxide, a lithium cobalt-based oxide, a lithium manganese-based oxide, a lithium iron phosphate-based compound, a cobalt-free lithium nickel-manganese-based oxide, or a combination thereof.

As an example, a compound represented by any of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, at least one of a lithium nickel-based oxide represented by Chemical Formula 11, a lithium cobalt-based oxide represented by Chemical Formula 12, a lithium iron phosphate-based compound represented by Chemical Formula 13, a cobalt-free lithium nickel-manganese-based oxide represented by Chemical Formula 14, or a combination thereof.

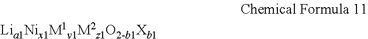

In Chemical Formula 11, 0.9≤a1≤1.8, 0.3≤x1≤1, 0≤y1≤0.7, 0≤z1≤0.7, 0.9≤x1+y1+z1≤1.1, and 0≤b1<0.1, M¹ and M² each independently are or include one or more of Al, B, Ba, Ca, Ce, Co, Cr, Cu, Fe, Mg, Mn, Mo, Nb, Si, Sn, Sr, Ti, V, W, and Zr, and X is or includes one or more of F, P, and S.

In Chemical Formula 11, 0.6≤x1≤1, 0≤y1≤0.4, and 0≤z1≤0.4, or 0.8≤x1≤1, 0≤y1≤0.2, and 0≤z1≤0.2.

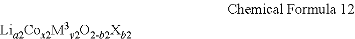

In Chemical Formula 12, 0.9≤a2≤1.8, 0.7≤x2≤1, 0≤y2≤0.3, 0.9≤x2+y2≤1.1, and 0≤b2≤0.1, M³ is or includes one or more of Al, B, Ba, Ca, Ce, Cr, Cu, Fe, Mg, Mn, Mo, Ni, Se, Si, Sn, Sr, Ti, V, W, Y, Zn, and Zr, and X is or includes one or more of F, P, and S.

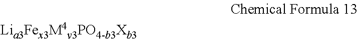

In Chemical Formula 13, 0.9≤a3≤1.8, 0.6≤x3≤1, 0≤y3≤0.4, and 0≤b3≤0.1, M⁴ is or includes one or more of Al, B, Ba, Ca, Ce, Co, Cr, Cu, Mg, Mn, Mo, Ni, Se, Si, Sn, Sr, Ti, V, W, Y, Zn, and Zr, and X is or includes one or more of F, P, and S.

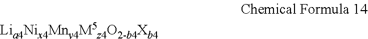

In Chemical Formula 14, 0.9≤a4≤1.8, 0.8≤x4<1, 0<y4≤0.2, 0≤z4≤0.2, 0.9≤x4+y4+z4≤1.1, and 0≤b4≤0.1, M⁵ is or includes one or more element such as at least one of Al, B, Ba, Ca, Ce, Cr, Fe, Mg, Mo, Nb, Si, Sn, Sr, Ti, V, W, and Zr, and X is or includes one or more of F, P, and S.

For example, the positive electrode active material may be or include a high-nickel positive electrode active material in which the nickel content is greater than or equal to about 80 mol %, greater than or equal to about 85 mol %, greater than or equal to about 90 mol %, greater than or equal to about 91%, or greater than or equal to about 94 mol % and less than or equal to about 99 mol %, based on 100 mol % of metal excluding lithium in the lithium transition metal composite oxide. The high-nickel positive electrode active material can achieve high capacity and can be applied to high-capacity, high-density rechargeable lithium batteries.

### Positive Electrode

The positive electrode for a rechargeable lithium battery may include a current collector, and a positive electrode active material layer on the current collector. The positive electrode active material layer may include a positive electrode active material, and may further include a binder and/or a conductive material.

For example, the positive electrode may further include an additive that can function as a sacrificial positive electrode.

A content of the positive electrode active material may be in a range of about 90 wt % to about 99.5 wt % based on 100 wt % of the positive electrode active material layer, and the content of each of the binder and the conductive material may be in a range of about 0.5 wt % to about 5 wt % based on 100 wt % of the positive electrode active material layer.

The binder is configured to improve binding properties of positive electrode active material particles with one another, and with a current collector. Examples of binders may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

The conductive material is included to provide electrode conductivity, and any electrically conductive material may be used as a conductive material unless the electrically conductive material causes an adverse chemical change in the battery. Examples of the conductive material may include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include at least one of a Si-based negative electrode active material or a Sn-based negative electrode active material. The Si-based negative electrode active material may include at least one of silicon, a silicon-carbon composite, SiOₓ (0<x<2), a Si-Q alloy (wherein Q is an element such as or including at least one of an alkali metal, an alkaline-earth metal, a Group 13 element, a Group 14 element (excluding Si), a Group 15 element, a Group 16 element, a transition metal, a rare earth element, and a combination thereof), or a combination thereof. The Sn-based negative electrode active material may be or include at least one of Sn, SnO₂, a Sn-based alloy, or a combination thereof.

The silicon-carbon composite may be or include a composite of silicon and amorphous carbon. According to some example embodiments, the silicon-carbon composite may be in the form of silicon particles, and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core.

The Si-based negative electrode active material or Sn-based negative electrode active material may be mixed with the carbon-based negative electrode active material.

### Negative Electrode

A negative electrode for a rechargeable lithium battery includes a current collector and a negative electrode active material layer on the current collector. The negative electrode active material layer includes a negative electrode active material, and may further include a binder and/or a conductive material. The binder may be or include a binder of the aforementioned embodiment.

For example, the negative electrode active material layer may include about 90 wt % to about 99 wt % of the negative electrode active material, about 0.5 wt % to about 5 wt % of the binder, and about 0.5 wt % to about 5 wt % of the conductive material.

The binder is configured to adhere the negative electrode active material particles to each other, and to adhere the negative electrode active material to the current collector. The binder may be or include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is included as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed. The alkali metal may be or include at least one of Na, K, or Li.

The dry binder may be or include a polymer material capable of becoming fiber, and may be or include, for example, at least one of polytetrafluoroethylene, polyvinylidene fluoride, a polyvinylidene fluoride-hexafluoropropylene copolymer, polyethylene oxide, or a combination thereof.

The conductive material is included to provide electrode conductivity, and any electrically conductive material may be included as a conductive material unless the electrically conductive material causes an adverse chemical change in the battery. Examples of the conductive material include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

The negative electrode current collector may include at least one of a copper foil, a nickel foil, a stainless steel foil, a titanium foil, a nickel foam, a copper foam, a polymer substrate coated with a conductive metal, and a combination thereof.

### Electrolyte Solution

An electrolyte solution for a rechargeable lithium battery includes a non-aqueous organic solvent and a lithium salt.

The non-aqueous organic solvent is configured as a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether group, and the like; amides such as dimethylformamide; dioxolanes such as 1,3-dioxolane, 1,4-dioxolane, and the like; sulfolanes, and the like.

The non-aqueous organic solvent may be included alone or in a mixture of two or more types of solvents.

In addition, when using a carbonate-based solvent, a cyclic carbonate and a chain carbonate may be mixed, and the cyclic carbonate and the chain carbonate may be mixed in a volume ratio in a range of about 1:1 to about 1:9.

The electrolyte solution may further include at least one of vinylethyl carbonate, vinylene carbonate, fluoroethylene carbonate, difluoro ethylenecarbonate, chloroethylene carbonate, dichloroethylene carbonate, bromoethylene carbonate, dibromoethylene carbonate, nitroethylene carbonate, cyanoethylene carbonate, or a combination thereof as an additive.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LiPO₂F₂, LiCl, Lil, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethane sulfonate, lithium difluorobis(oxalato) phosphate (LiDFOB), and lithium bis(oxalato) borate (LiBOB).

### Separator

Depending on the type of rechargeable lithium battery, a separator may be present between the positive and negative electrodes. Such a separator may include at least one of polyethylene, polypropylene, polyvinylidene fluoride, or a multilayer film of two or more layers thereof, and a mixed multilayer film such as a polyethylene/polypropylene two-layer separator, a polyethylene/polypropylene/polyethylene three-layer separator, a polypropylene/polyethylene/polypropylene three-layer separator, and the like.

The separator may include a porous substrate and a coating layer including an organic material, an inorganic material, or a combination thereof on one surface, or on both surfaces, of the porous substrate.

The porous substrate may be or include a polymer film formed of or including any one polymer such as at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked together.

### Rechargeable Lithium Battery

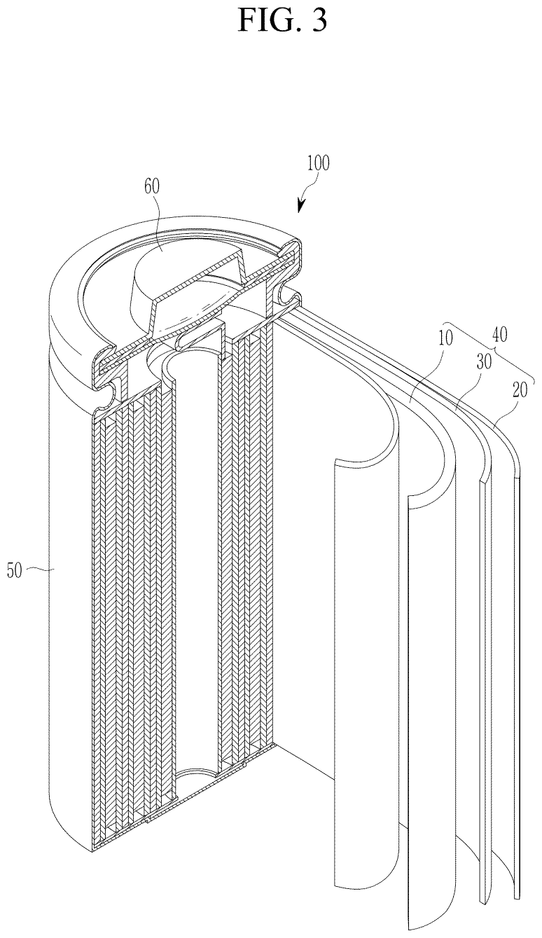

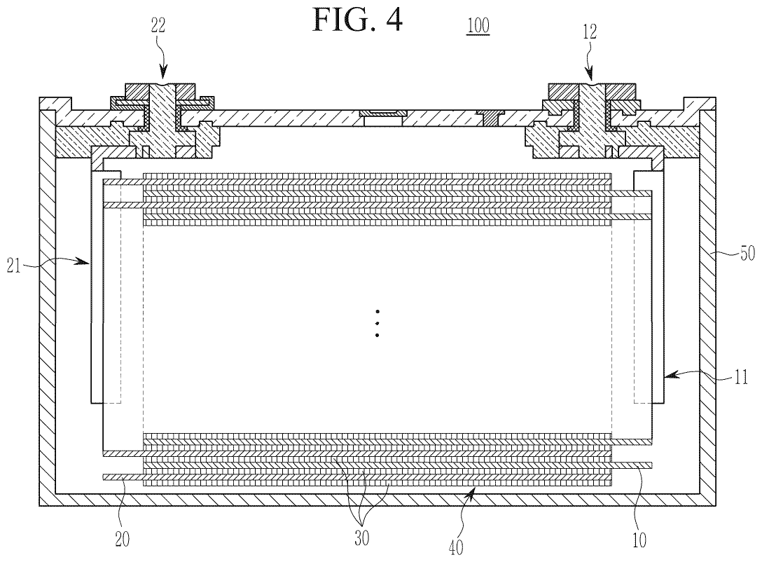

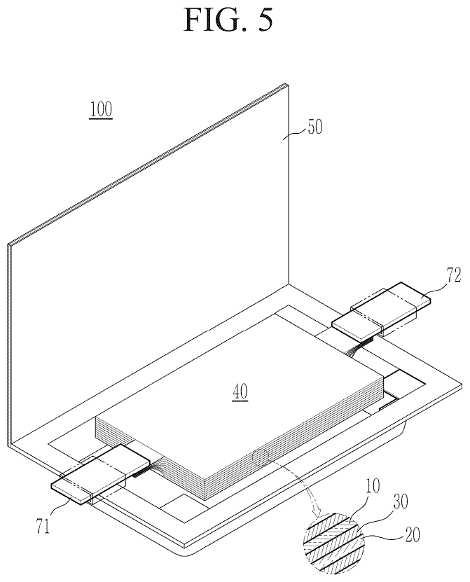

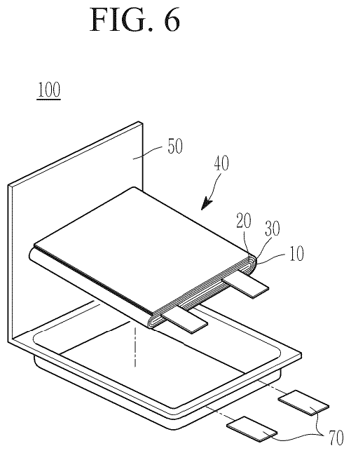

The rechargeable lithium battery may be classified into cylindrical, prismatic, pouch, or coin-type batteries, and the like, depending on the shape thereof. FIG. 3 to FIG. 6 are schematic views illustrating the rechargeable lithium battery according to some example embodiments, where FIG. 3 is a cylindrical battery, FIG. 4 is a prismatic battery, and FIG. 5 and FIG. 6 are a pouch-shaped battery. Referring to FIG. 3 to FIG. 6, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 3. As illustrated in FIG. 4, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 5 and FIG. 6, the rechargeable lithium battery 100 includes an electrode tab 70 illustrated in FIG. 6, or a positive electrode tab 71 and a negative electrode tab 72 illustrated in FIG. 5, the electrode tabs 70/71/72 forming an electrical path for inducing the current formed in the electrode assembly 40 to the outside of the battery 100.

The rechargeable lithium battery according to some example embodiments may be applicable to automobiles, mobile phones, and/or various types of electrical devices, but the present disclosure is not limited thereto.

Examples and comparative examples of the present disclosure are described below. However, the following examples are only examples of the present disclosure, and the present disclosure is not limited to the following examples.

### Example 1

### (1) Manufacturing of Negative Electrode

On a 10 μm-thick Cu foil, a plurality of hydrophilic flow paths were formed in a stripe shape (width per hydrophilic flow path: 3 mm, spacing between adjacent hydrophilic flow paths: 1.5 mm) using SiO₂ (D50<5 μm). For this purpose, an Automatic film applicator device was used and operated under the condition of 10 m/min.

A negative electrode active material slurry was prepared by using a mixture of graphite and silicon particle mixed in a weight ratio of 92:8 as a negative electrode active material, mixing the negative electrode active material:styrene-butadiene rubber binder:carboxylmethyl cellulose in a weight ratio of 97:1:2, and then, dispersing the obtained mixture in distilled water.

The negative electrode active material slurry was coated on a Cu foil in which the hydrophilic flow path was formed and then, dried at 100° C. and pressed to form a negative electrode active material layer.

### (2) Preparation of Electrolyte Solution

An electrolyte solution was prepared by mixing 1.5 M lithium salt (LiPF₆) with a carbonate solvent including ethylene carbonate (EC):ethyl methyl carbonate (EMC):dimethyl carbonate (DMC) mixed in a volume ratio of 20:10:70.

### (3) Manufacturing of Rechargeable Lithium Battery Cell

A rechargeable lithium battery cell was manufactured by disposing a 10 μm-thick polyethylene separator between the manufactured negative electrode and a 10 μm-thick Li foil as a counter electrode to obtain an electrode assembly, housing the electrode assembly in a cylindrical case, and injecting the electrolyte solution thereinto.

### Example 2

A negative electrode and a rechargeable lithium battery cell according to Example 2 were manufactured in the same manner as in Example 1, with a difference that each hydrophilic flow path was formed to have a width: 5 mm and a space between neighboring hydrophilic flow paths: 5 mm.

### Example 3

A negative electrode and a rechargeable lithium battery cell according to Example 3 were manufactured in the same manner as in Example 1, with a difference that each hydrophilic flow path was formed to have a width: 3 mm and a space between neighboring hydrophilic flow paths: 5 mm.

### Example 4

A negative electrode and a rechargeable lithium battery cell according to Example 4 were manufactured in the same manner as in Example 1, with a difference that each hydrophilic flow path was formed to have a width: 3 mm and a space between neighboring hydrophilic flow paths: 10 mm.

### Example 5

A negative electrode and a rechargeable lithium battery cell according to Example 5 were manufactured in the same manner as in Example 1, with a difference that each hydrophilic flow path was formed to have a width: 3 mm and a space between neighboring hydrophilic flow paths: 30 mm.

### Comparative Example 1 (Ref.)

A negative electrode and a rechargeable lithium battery cell according to Comparative Example 1 were manufactured in the same manner as in Example 1, with a difference that the hydrophilic flow path was not formed.

### Evaluation Example 1: Evaluation of Negative Electrode

Each of the negative electrodes of Examples 1 to 5 and Comparative Example 1 were evaluated with respect to an impregnation amount of an electrolyte solution over time in the following method, and the results are shown in Table 1.
1) The negative electrode was cut into a width*a length=60 mm*40 mm.
2) The negative electrode cut in the 1) was fixed to an equipment of Biolin Scientific AB (model name: Sigma 700).
3) The negative electrode fixed in the 2) was immersed to a length of 10 mm in an electrolyte solution.
4) The negative electrode immersed in the electrolyte solution in the 3) was measured with respect to a weight over time.

TABLE 1

| | | Comparative | | | | | |
|---|---|---|---|---|---|---|---|
| | | Example 1 | Example 1 | Example 2 | Example 3 | Example 4 | Example 5 |
| Hydrophilic | width | — | 3 | 5 | 3 | 3 | 3 |
| flow path | spacing | — | 1.5 | 5 | 5 | 10 | 30 |
| Impregnation | 10 | 0.24 | 0.96 | 0.89 | 0.61 | 0.35 | 0.25 |
| time (sec) | 40 | 0.52 | 1.83 | 1.62 | 1.21 | 0.72 | 0.55 |
| | 70 | 0.96 | 2.18 | 2.11 | 1.78 | 1.25 | 1.01 |
| | 120 | 2.15 | 2.52 | 2.34 | 2.29 | 2.25 | 2.10 |
| | 170 | 2.24 | 2.74 | 2.59 | 2.52 | 2.33 | 2.30 |
| | 200 | 2.36 | 2.85 | 2.62 | 2.57 | 2.50 | 2.42 |
| | 230 | 2.45 | 2.93 | 2.65 | 2.62 | 2.53 | 2.47 |
| | 260 | 2.54 | 3.01 | 2.79 | 2.61 | 2.55 | 2.53 |
| | 300 | 2.53 | 3.10 | 2.87 | 2.70 | 2.60. | 2.57 |

### Evaluation Example 2: Evaluation of Rechargeable Lithium Battery Cell

The rechargeable lithium battery cells of Examples 1 to 5 and Comparative Example 1 were evaluated in the following method, and the results are shown in Table 2.

The rechargeable lithium battery cells were 30 cycles charged and discharged under conditions of 1.0 C charge (CC/CV, 1.2 V, 0.025 C Cut-off)/1.0 C discharge (CC, 0 V Cut-off) and 25° C. to calculate a capacity retention rate according to Equation 1.

TABLE 2

| | Comparative | | | | | |
|---|---|---|---|---|---|---|
| | Example 1 | Example 1 | Example 2 | Example 3 | Example 4 | Example 5 |
| Room-temperature cycle- | 68.5% | 80.2% | 81.6% | 81.7% | 72.7% | 69.2% |
| life characteristics | | | | | | |
| (30 cyc., 25° C.) | | | | | | |

### SUMMARY

The electrodes of some example embodiments represented by Examples 1 to 5 may allow an aqueous electrolyte solution to substantially uniformly wet the substrate and the active material layer through a hydrophilic material and shorten the diffusion time of the aqueous electrolyte solution into the substrate and the active material layer.

The electrodes according to some example embodiments may reduce a side reaction due to non-uniform wettability of the electrodes, and improve capacity and cycle-life characteristics of rechargeable lithium batteries.

Herein, the electrodes were manufactured as negative electrodes for convenience, but even when manufactured as positive electrodes, desired or improved performance similar to the performance of Examples 1 to 5 may be accomplished.

While this disclosure has been described in connection with what is presently considered to be practical example embodiments, it is to be understood that the disclosure is not limited to the disclosed embodiments. On the contrary, the disclosure is intended to cover various modifications and equivalent arrangements included within the spirit and scope of the appended claims.

Description of Symbols:

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. An electrode for a rechargeable lithium battery, the electrode comprising:
a substrate;
a hydrophilic flow path disposed on the substrate and including a hydrophilic material; and
an active material layer in contact with the substrate and the hydrophilic flow path.

2. The electrode as claimed in claim 1, wherein the hydrophilic material comprises at least one of SiO₂, Al₂O₃, ZnO, MgO, ZrO₂, TiO₂, SnO₂, CeO₂, CaO, SrO, BaO, Na₂O, B₂O₃, Mn₂O₃, Y₂O₃, and WO₃.

3. The electrode as claimed in claim 1, wherein:
the hydrophilic flow path is plural, and
the active material layer is in contact with the substrate and the hydrophilic flow path and is between and on the adjacent hydrophilic flow paths.

4. The electrode as claimed in claim 1, wherein:
the hydrophilic flow path is plural, and
the hydrophilic flow path has one of:
a stripe shape in which a plurality of straight lines are arranged in parallel in a longitudinal direction on the substrate; and
a mesh-shaped structure in which a plurality of straight lines arranged in a longitudinal direction and a plurality of straight lines arranged in a width direction intersect on the substrate.

5. The electrode as claimed in claim 4, wherein in the hydrophilic flow path having the stripe shape:
a width of each hydrophilic flow path is in a range of about 0.1 mm to about 10 mm.

6. The electrode as claimed in claim 5, wherein in the hydrophilic flow path having the stripe shape:
a spacing between adjacent hydrophilic flow paths is in a range of about 1 mm to about 50 mm.

7. The electrode as claimed in claim 6, wherein in the hydrophilic flow path having the stripe shape:
a ratio of the width and the spacing is in a range of about 1:0.5 to about 1:10.

8. The electrode as claimed in claim 1, wherein:
an area of the hydrophilic flow path is in a range of about 1 sq % to about 60 sq % based on 100 sq % of a total area of the substrate.

9. A rechargeable lithium battery, comprising:
an electrode assembly comprising a positive electrode, a separator, and a negative electrode; and
an electrolyte,
wherein at least one of the positive electrode and the negative electrode comprises the electrode as claimed in claim 1.

10. The rechargeable lithium battery as claimed in claim 9, wherein:
the electrode assembly has a wound jelly roll structure, and
the hydrophilic flow path has a shape that is substantially orthogonal to the winding direction of the electrode assembly.
